(19) United States
(12) Patent Application Publication
(10) Pub. No.: US 2018/0309352 A1
(43) Pub. Date: Oct. 25, 2018

(54) DC MOTOR WITH MULTIPLIED TORQUE

(71) Applicant: LIVID ZHUANG, TAOYUAN CITY (TW)

(72) Inventor: LIVID ZHUANG, TAOYUAN CITY (TW)

(21) Appl. No.: 15/911,410

(22) Filed: Mar. 5, 2018

(30) Foreign Application Priority Data
Apr. 21, 2017 (TW) 106113461

(51) Int. Cl. H02K 29/08; H02P 6/10

(52) U.S. Cl. CPC H02K 29/08; H02P 6/10

(57) ABSTRACT

A DC motor includes a driver, a Hall rotor position detector, an electromagnet stator and a permanent magnet rotor. The driver includes a rotor position signal amplifier and a power amplifier. The rotor position detector includes six Hall sensing crystals and an induced magnet fixed to a motor shaft. A rotor pole position signal is detected by the Hall effect between the induced magnet and the Hall sensing crystals. Power is amplified by the power amplifier and supplied to a winding of an electromagnet stator, so that the pole of electromagnet stator keeps repelling and attracting the pole of the permanent magnet rotor to produce a multiplied torque according to the relative displacement to drive the generator by the multiplied torque and achieve the effects of outputting an electric power greater than the electric power provided for the operation of the motor, amplifying the electric power, and saving energy.

### TECHNICAL FIELD

The technical field relates to a direct current (DC) motor with a multiplied torque, and more particularly to a simple and safe DC motor with a stator pole which is always repelled first and then attracted later with a rotor pole through a rotor position signal to produce a relative displacement to provide a multiplied torque, so as to form a combined torque greater an the torque of a single stator to drive a generator to generate electric power, and the electric power outputted by the generator is always greater than the electric power supplied for the operation of the DC motor, so as to achieve the purpose of substantial amplification of the electric power and the effect of multiplied torque.

### BACKGROUND

A conventional AC motor, regardless of an AC induction motor or an AC synchronous motor, generates a rotating magnetic field to attract the unlike pole of the rotor for an interlock after a current is connected to a stator winding, so that the rotor rotates with the rotating magnetic field of the stator, wherein the stator pole and the rotor pole attract each other, and the mutual attraction is added to the action and reaction of the stator and rotor, so that the rotor and stator are interlocked in a static equilibrium state without any repulsion between the magnetic fields, and the mutual attraction applies an action force to the torque of the relative displacement produced by each other. In other words, the two poles have an included angle=0, no relative displacement, a power=0, and a resultant force=0, and the function of the rotor simply acts as a transmission shaft between the stator and a load without producing any torque, and the power source of the motor completely comes from a single torque of the stator current.

The conventional DC motor is operated by the force of a current-carrying conductor in the magnetic field. Since the rotor conductor operating in the magnetic field will cut the field flux to produce an inductive potential, and the direction of such inductive potential is opposite to the direction of an external electric potential, such inductive potential always repels the addition of an external electric potential and thus is called reverse potential and has the features of small armature current, small torque, low rotating speed, small electric potential, large armature current, and large torque. Although the armature pole and stator pole also produce a relative displacement, the resultant torque is also greater than the torque of a single armature. When the torque increases, the rotating speed decreases, so that the outputted NT is still equal to VI. Therefore, no matter how it is improved, the energy saving effect is very limited.

In addition a more advanced DC brushless motor attracts the rotor by a change of six switches to achieve the effect of rotating the motor by six fixed points, and its advantages include preventing sparks and noises produced by the friction of the brush and requiring no maintenance. Although the efficiency of the DC brushless motor is higher than that of the DC brush motor, the relation of their input and output is still constant. As a result, the improvement of the power saving effect is still very limited.

### SUMMARY

Therefore, it is a primary objective of this disclosure to provide a DC motor with a multiplied torque to improve the conventional motor having a resultant torque always smaller than the torque of a single stator, and the DC motor uses a rotor position signal to keep the stator pole always repelling and then attracting the rotor pole to produce a relative displacement to obtain a multiplied torque, so that the multiplied torque is greater than the torque of a single stator, and the multiplied torque is used to drive the generator to generate power, so as to achieve the effects of outputting an electric power by generator greater than the electric power supplied for the operation of the motor, amplifying the electric power and saving energy.

To achieve the aforementioned and other objectives, this disclosure provides a DC motor with multiplied torque, and the DC motor comprises a driver, a Hall rotor position detector, an electromagnet stator and a permanent magnet rotor. Wherein, the driver comprises a rotor position signal amplifier and a power amplifier; the rotor position detector includes six Hall sensing crystals and an induced magnet fixed to a motor shaft. A rotor pole position signal is detected by the Hall effect between the induced magnet coaxially operated with the motor and the Hall sensing crystals. After the power amplifier of the driver amplifies the power which is supplied to an electromagnet stator winding of the motor, so that the electromagnet stator pole keeps repelling and then attracting the pole of the permanent magnet rotor and produces a multiplied torque according to the relative displacement, so as to drive the power generation of a generator by the multiplied torque and achieve the effects of outputting an electric power greater than the electric power provided for the operation of the motor, amplifying the electric power, and saving energy.

The objectives, technical characteristics and effects of this disclosure will become clearer in light of the following detailed description of an illustrative embodiment described in connection with the related drawings.

### BRIEF DESCRIPTION OF THE DRAWINGS

FIG. 1 is a system block diagram of a preferred embodiment of this disclosure;

FIG. 2 is a schematic view of a DC motor with a multiplied torque in accordance with a preferred embodiment of this disclosure;

FIG. 3A is a schematic view showing the waveforms of the signals of a rotor position detector in accordance with a preferred embodiment of this disclosure;

FIG. 3B is a first schematic view showing the configuration of each Hall sensing crystal and an induced magnet of a rotor position detector in accordance with a preferred embodiment of this disclosure;

FIG. 3C is a second schematic view showing the configuration of each Hall sensing crystal and an induced magnet of a rotor position detector in accordance with a preferred embodiment of this disclosure;

FIG. 4A is a schematic view showing the configuration and position of an induced magnet, a permanent magnet and a motor shaft in accordance with a preferred embodiment of this disclosure;

FIG. 4B is a schematic view showing the mechanical angle of a winding in each phase of an electromagnet stator in accordance with a preferred embodiment of this disclosure;

FIG. 4C is a schematic view showing the magnetic field of the winding in each phase of an electromagnet stator in accordance with a preferred embodiment of this disclosure;

FIG. 4D is a schematic view of a permanent magnet rotor in accordance with a preferred embodiment of this disclosure;

FIG. 4E is a schematic view showing the pole arrangement of an electromagnet stator in accordance with a preferred embodiment of this disclosure;

FIG. 4F is a schematic view showing the position of a Hall sensing crystal of a rotor position detector and each pole of an electromagnet stator in accordance with a preferred embodiment of this disclosure;

FIG. 4G is a schematic view showing the configuration of tri-phase poles of an electromagnet stator in accordance with a preferred embodiment of this disclosure;

FIG. 5 is a schematic view showing the analysis of the operation of a motor in accordance with a preferred embodiment of this disclosure;

FIG. 6A is a schematic view of a rear end of the N pole of a permanent magnet rotor entering into an angle of 10° with respect to a position under the N pole of a pole face of an U-phase electromagnet stator in accordance with a preferred embodiment of this disclosure;

FIG. 6B is a schematic view of an end of an induced magnet situated at a position beyond the center point of a W-phase Hall sensing crystal in accordance with a preferred embodiment of this disclosure;

FIG. 6C is a schematic view of a rear end of the N pole of a permanent magnet rotor entering into an angle of 10° with respect to a position under a pole face of the N pole of a V-phase electromagnet stator in accordance with a preferred embodiment of this disclosure;

FIG. 6D is a schematic view of an end of an induced magnet situated at a position beyond the center point of an U-phase Hall sensing crystal in accordance with a preferred embodiment of this disclosure;

FIG. 6E is a schematic view of a rear end of the N pole of a permanent magnet rotor entering into an angle of 10° with respect to a position under a pole face of the N pole of a W-phase electromagnet stator in accordance with a preferred embodiment of this disclosure;

FIG. 6F is a schematic view of an end of an induced magnet situated at a position beyond the center point of a V-phase Hall sensing crystal in accordance with a preferred embodiment of this disclosure; and

FIG. 7 is a schematic view of an angular configuration of an excitation switch of a motor in accordance with a preferred embodiment of this disclosure.

### DESCRIPTION OF THE PREFERRED EMBODIMENTS

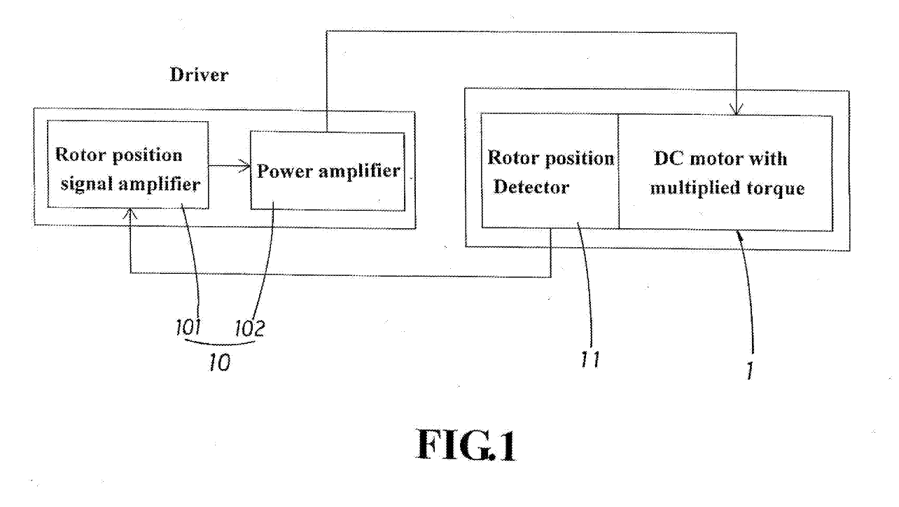

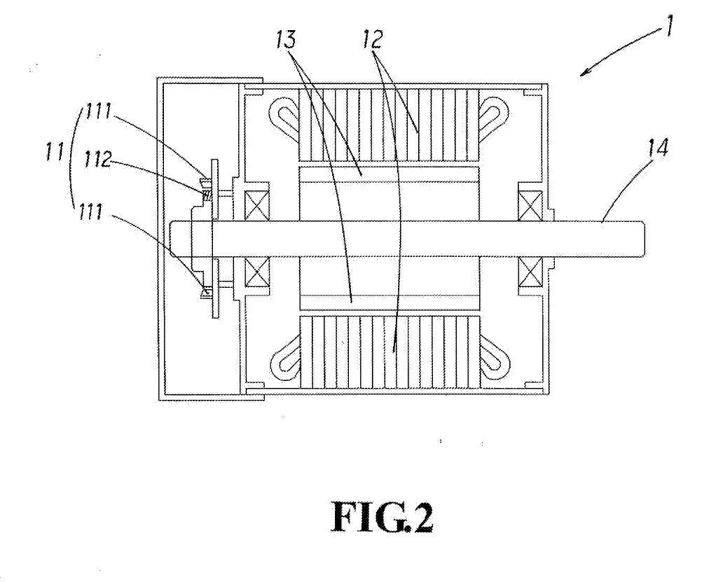

With reference to FIGS. 1 to 4 for a DC motor with a multiplied torque 1 of this disclosure, the DC motor with a multiplied torque 1 (as shown in FIGS. 1 and 2) comprises a driver 10, a Hall rotor position detector 11, an electromagnet stator 12 and a permanent magnet rotor 13.

The driver 10 (as shown in FIG. 1) comprises a rotor position signal amplifier 101 and a power amplifier 102;

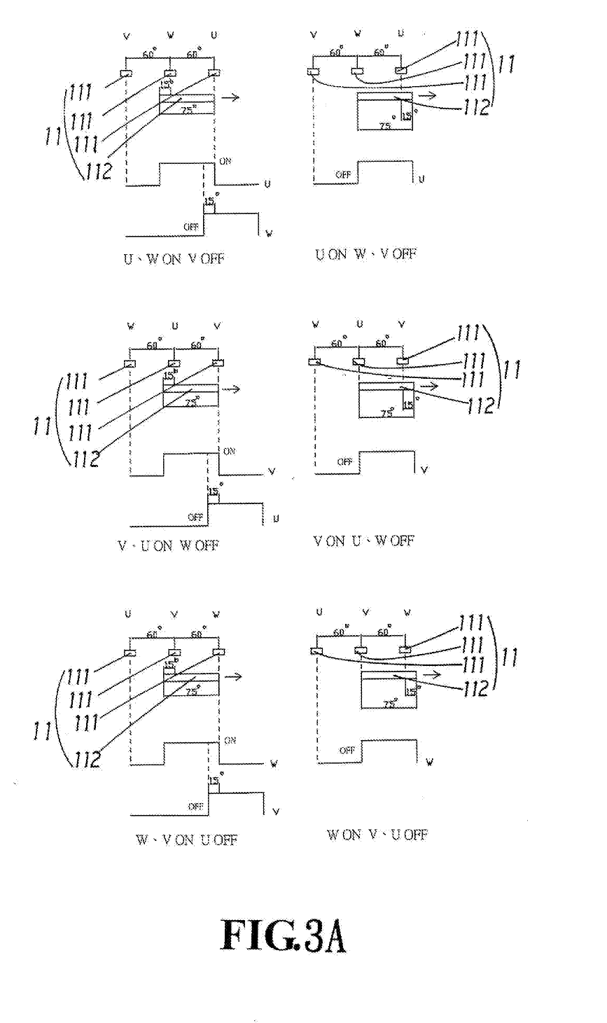

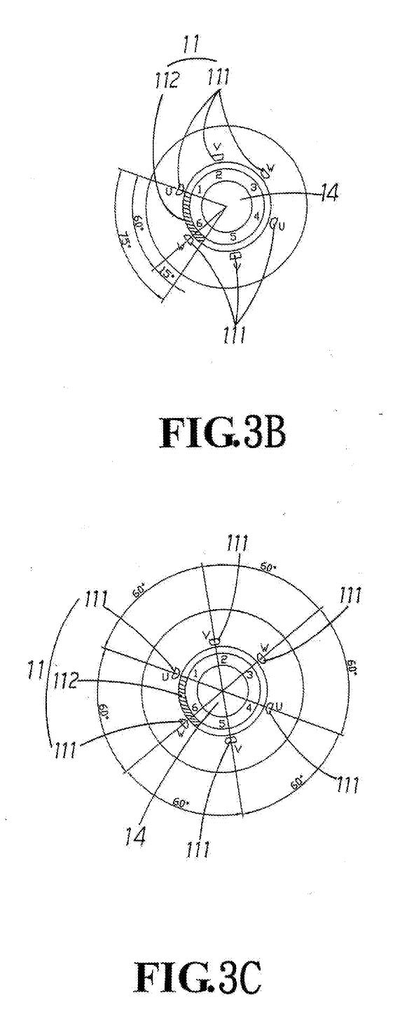

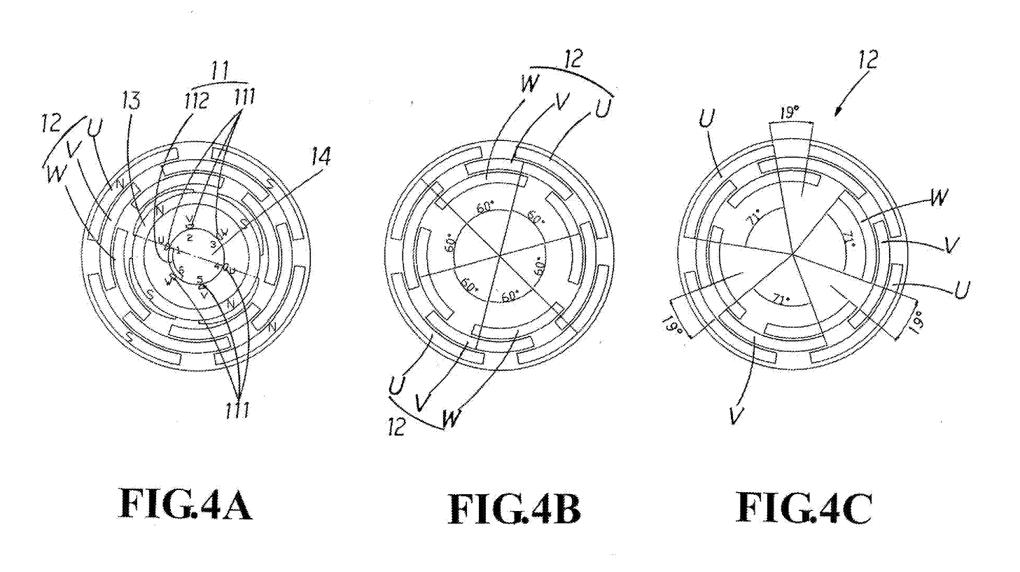

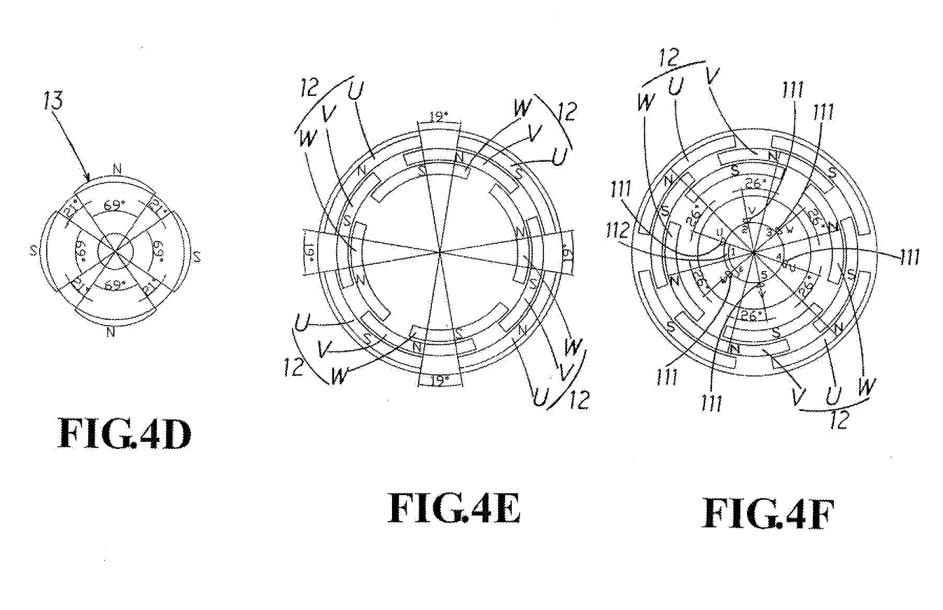

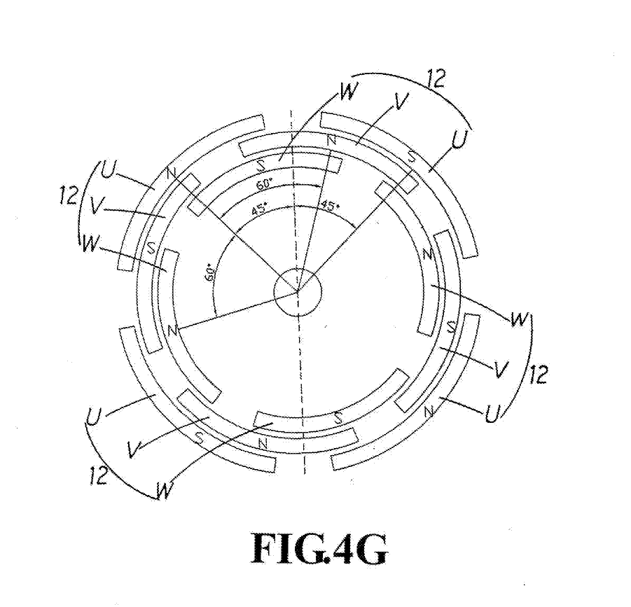

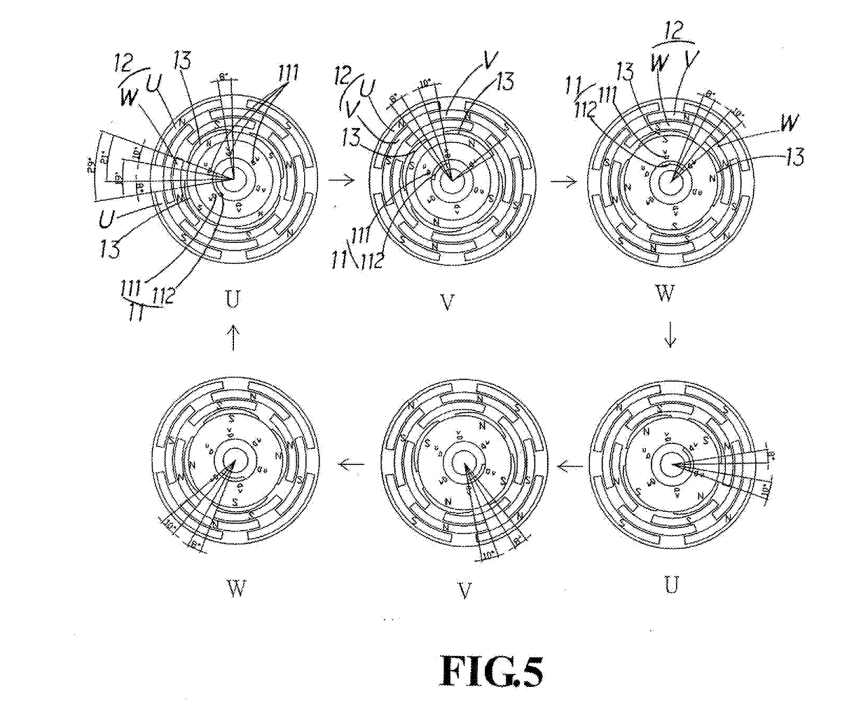

The structure, operation waveform and angle of the rotor position detector 11 are shown in FIGS. 2, 3A, 3B, and 3C, and the rotor position detector 11 is comprised of six Hall sensing crystals 111 and an induced magnet 112 fixed to a motor shaft 14. Wherein, the six Hall sensing crystals 111 are separated with a mechanical angle of 60° from one another. The induced magnet 112 is fixed onto the motor shaft 14 with a width equal to a mechanical included angle of 75° (as shown in FIG. 3B) and synchronously operated with the motor, and the induced magnet 112 is installed across two Hall sensing crystals 111, and when the front Hall sensing crystal 111 is sensed to be in an ON state by the induced magnet 112 rotated clockwise with the motor shaft 14, the adjacent rear Hall sensing crystal 111 is delayed by a mechanical angle of 15° and turned OFF, so that the excitations of two adjacent magnetic fields are overlapped at a mechanical angle of 15°. In other words, when the induced magnet 112 rotates clockwise with the motor shaft 14 and the front edge of the induced magnet 112 arrives the center point under a surface of any Hall sensing crystal 111, the Hall sensing crystal 111 is in an ON state, and the Hall sensing crystal 111 is adjacent to the rear Hall sensing crystal 111, and has a spacing of a mechanical angle of 60° from the adjacent front Hall sensing crystal 111, and the width of an included angle of the induced magnet 112 is equal to a mechanical angle of 75°, so that the adjacent rear Hall sensing crystal 111 is delayed by a mechanical angle of 15° and turned OFF, and the excitations of the two adjacent magnetic fields are overlapped at a mechanical angle of 15°. In other words, the ON and OFF operations and waveform of each Hall sensing crystal 111 are as shown in FIG. 3A. When the induced magnet 112 rotates clockwise with the motor shaft 14 to turn on U, W is delayed by a mechanical angle of 15° and turned OFF, and only U is ON. When V is ON, U is delayed by a mechanical angle of 15° and turned OFF, and only V is ON. When W is ON, V is delayed by a mechanical angle of 15° and turned OFF, and only W is ON, and two out of the three coils of the electromagnet stator 12 are conducted. In other words, when two out of three coils of the electromagnet stator 12 are overlapped at a mechanical angle of 15° to conduct the excitation simultaneously, only one coil is not conducted. When only one of three coils of the electromagnet stator 12 is conducted, two coils are not conducted. Each Hall sensing crystal 111 is configured at 26° on the left side of the center point under the pole face of the N pole of each electromagnet stator 12 (as shown in FIG. 4F), the sequence is U→V→W→U→V→W. Viewing from the motor shaft, a radial section including the motor shaft 14, induced magnet 112 and permanent magnet rotor 13 is observed. Viewing from the clockwise direction, the rear ends of two N poles of the permanent magnet rotor 13, the front edge of the induced magnet 112, and the center point of the motor shaft 14 are configured and extended linearly with respect to one another (as shown in FIG. 4A).

The electromagnet stator 12 is comprised of three windings (U, V, and W) and the mechanical angles of the windings have a difference of 60° (as shown in FIG. 4B), and the three-phase windings of the electromagnet stator 12 are arranged into three layers in the radial direction of the motor, and the windings of different phases are overlapped with each other, and each winding has 4 poles, each having a pole width equal to a mechanical angle of 71°, and each pole is spaced by a mechanical angle of 19° (as shown in FIGS. 4C and 4E), and the poles are arranged adjacent to each other sequentially (N→S→N), and the sequence of phases is (U→V→W), and the polar direction of the magnetic field (as shown in FIG. 4G) is arranged at the center of the N pole of the U-phase electromagnet stator 12 which is a mechanical angle of 45° on the left side of the center line perpendicular to the motor, and a mechanical angle of 45° on the right side is the center of the S pole of the U-phase electromagnet stator 12, and a mechanical angle of 60° on the right side of the N pole of the U-phase electromagnet stator 12 is the center of the N pole of the V-phase electromagnet stator 12, and a mechanical angle of 60° on the right side is the center of the N pole of the W-phase electromagnet stator 12. In other words, the magnetic fields of the electromagnet stators 12 are arranged in a way of having a radial section of the magnetic field winding, wherein the middle of a side of the circumference is V-phase, and the polar direction is S pole; the left side is U-phase, and the polar direction is N pole; the right side is W-phase, and the polar direction is N pole, viewing from the axial direction of the motor. The stators of different phases of the electromagnet stator 12 are wired by connecting Y, wherein the contact point Y and the other U, V, W ends of the contact point Y are DC power supply input ends to form a single-phase DC current input. Since the power supply is DC, and connected and disconnected alternately, therefore the polar direction of the magnetic field of each phase remains unchanged, and there is no need for a change of phases.

The rotor 13 is formed by a permanent magnet and has 4 poles (as shown in FIG. 4D), and each pole width is equal to a mechanical included angle of 69°, and the external periphery of the permanent magnet is in an arc shape, wherein the center point is thicker and both ends are thinner, and the poles are arranged sequentially into (N, S, N, S), and each pole is spaced with a mechanical angle of 21°.

In FIGS. 3B, 3C, 4A, and 4F, the six Hall sensing crystals 111 of the rotor position detector 11 are numbered sequentially into U which are 1 and 4, V which are 2 and 5, and W which are 3 and 6 and arranged clockwise sequentially according to the number. When the Hall sensing crystals 111 are arranged sequentially according to the number, when the permanent magnet rotor 13 rotates one round, the 6 Hall sensing crystals will detect 6 rotor position signals, and their sequence is (U1→V2→W3→U4→V5→W6) and the six Hall sensing crystals 111 senses the rotor position signals, and the first half round of the rotation of the permanent magnet rotor 13 is (U1→V2→W3), and the second half round of the rotation of the permanent magnet rotor 13 is (U4→V5→W6). Since the power supplied to the winding of the electromagnet stator 12 is a direct current (DC) power, the polar directions of the voltage inputted repeatedly into the windings of the electromagnet stator 12 of different phases (U1 and U4, V2 and V5, and W3 and W6) are the same. When the permanent magnet rotor 13 rotates one round, the coil of the electromagnet stator 12 of each phase will repeat the excitation twice, so that after the powers of the position signals detected by the first and fourth Hall sensing crystals 111 are amplified by the power amplifier 102 of the driver 10, the amplified power is supplied to the U-phase stator power supply of the motor. After the powers of the position signals detected by the second and fifth Hall sensing crystals 111 are amplified by the power amplifier 10 of the driver 10, the amplified power is supplied to the V-phase stator power supply of the motor. After the powers of the position signals detected by the third and sixth Hall sensing crystals 111 are amplified by the power amplifier 102 of the driver 10, the amplified power is supplied to the W-phase stator power supply of the motor.

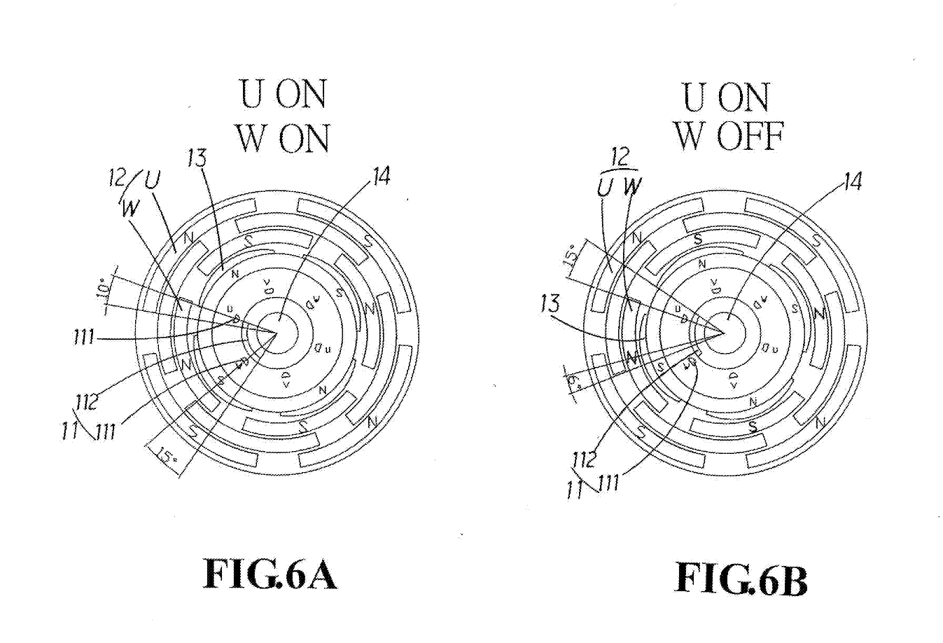

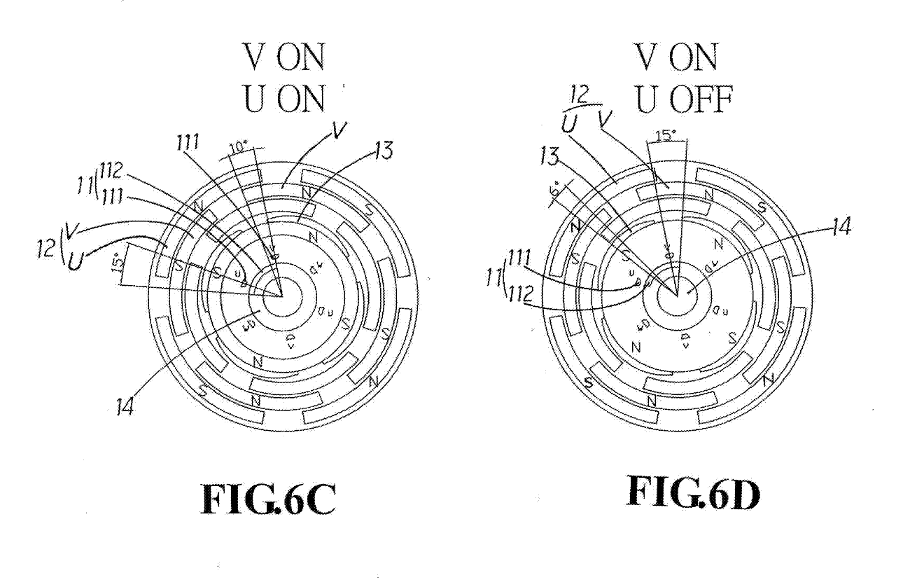

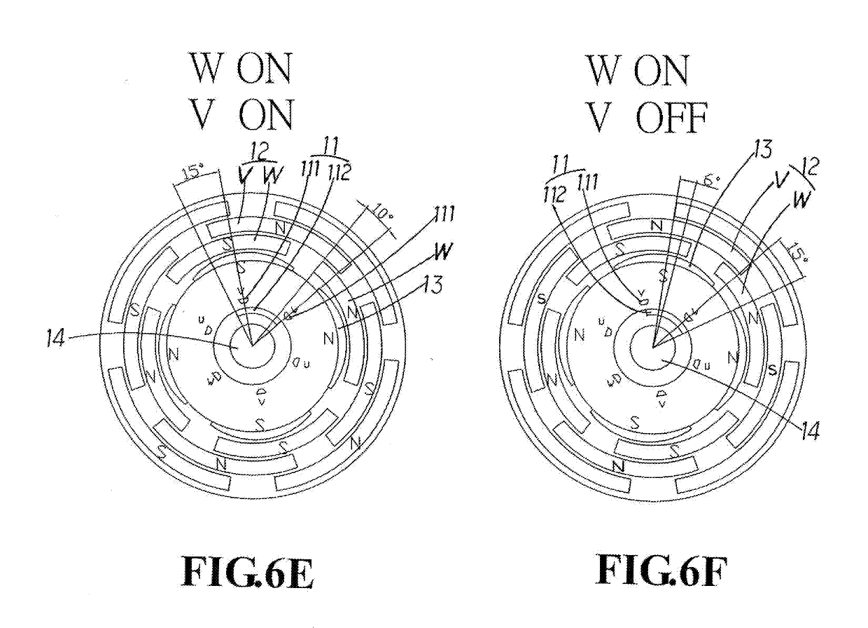

The principle of the operation of the DC motor with a multiplied torque in accordance this disclosure is described together with FIGS. 5 and 6 as follows:

In FIG. 5, before a power supply is added, at least one of the six Hall sensing crystals 111 of the rotor position detector 11 is situated within a sensing range of the induced magnet 112, regardless of the position where the pole of the permanent magnet rotor 13 of the DC motor 1 of this disclosure is situated. In other words, the electromagnet stator 12 at least has a winding connected to the excitation of the power supply. In an U-phase starting point used for example (as shown in FIGS. 5, 6A, and 6B), when the power is supplied, regardless of whether or not the W-phase is within the sensing range of the induced magnet 112 of the rotor position detector 11 and the rear of the N pole of the permanent magnet rotor 13 enters into the position of a mechanical angle of 10° under the pole face of the N pole of the U-phase electromagnet stator 12 (as shown in FIGS. 5 and 6A), the front edge of the S pole of the permanent magnet rotor 13 is beyond the mechanical angle of 8° of the front edge of the pole face of the S pole of the U-phase electromagnet stator 12 (as shown in FIG. 5), so that the N pole of the permanent magnet rotor 13 and the N pole of the U-phase electromagnet stator 12 will be like poles which repel each other. In other words, since the poles of different phases of the electromagnet stator 12 have a spacing of a mechanical angle of 19° from each other (as shown in FIG. 4E), and the rear of the two N poles of the permanent magnet rotor 13, the front edge of the induced magnet 112 of the rotor position detector 11, and the center point of the motor shaft 14 are configured and extended linearly with respect to one another (as shown in FIG. 4A), therefore when the rear of the N pole of the permanent magnet rotor 13 enters into the position of a mechanical angle of 10° under the pole face of the N pole of the U-phase electromagnet stator 12 (as shown in FIG. 5), the rear of the N pole of the permanent magnet rotor 13 and the front edge of the pole face of the S pole of the U-phase electromagnet stator 12 have a difference of a mechanical angle of 29° (10°+19°=29°). According to the aforementioned principle of operation, the poles of the permanent magnet rotor 13 are spaced by a mechanical angle of 21° (as shown in FIG. 4D), the front edge of the S pole of the permanent magnet rotor 13 is beyond the mechanical angle of 8° (29°−21°=8°) of the front edge of the pole face of the S pole of the U-phase electromagnet stator, and the N pole of the permanent magnet rotor 13 and the N pole of the U-phase electromagnet stator 12 are like poles which repel each other. Since the Hall sensing crystals 111 of the rotor position detector 11 are spaced by a mechanical angle of 60° (as shown in FIG. 3), the sensing range of the induced magnet 112 is set to be mechanical included angle of 75° (as shown in FIG. 3), and two Hall sensing crystals 111 have a difference of a mechanical angle of 15°, and the W-phase Hall sensing crystal 111 is still within the sensing range of the induced magnet 112 (as shown in FIG. 6A), and the winding of the W-phase electromagnet stator 12 is still situated in the excitation (as shown in FIG. 6A), so that the S pole of the permanent magnet rotor 13 and the N pole of the W-phase electromagnet stator 12 are unlike poles which attract each other (as shown in FIG. 6A). At this moment, two poles are repelled and attracted, so that the pole of the permanent magnet rotor 13 and the pole of the electromagnet stator 12 produce a relative displacement for the clockwise rotation, and when an end of the induced magnet 112 is beyond the center point of the W-phase Hall sensing crystal 111 (as shown in FIG. 6B), and the S pole of the permanent magnet rotor 13 is displaced to the mechanical angle of 6° before the equilibrium point for attracting the N pole of the W-phase electromagnet stator 12, the excitation of the W-phase electromagnet stator 12 will be turned off automatically (as shown in FIG. 6B), and only the U-phase electromagnet stator 12 continues the magnetic excitation, and the S pole of the permanent magnet rotor 13 continues repelling the S pole of the U-phase electromagnet stator 12 to produce a relative displacement, and thus the permanent magnet rotor 13 continues its clockwise rotation.

According to the aforementioned principle of operation, when the front of the induced magnet 112 enters into the V-phase Hall sensing crystal 111 as shown in FIGS. 5, 6C, and 6D, the rear of the N pole of the permanent magnet rotor 13 has entered into the mechanical angle of 10° under the pole face of the N pole of the V-phase electromagnet stator 12 (as shown in FIGS. 5 and 6C), and the front edge of the S pole of the permanent magnet rotor 13 is already beyond the mechanical angle of 8° under of the pole face of the S pole of the V-phase electromagnet stator 12 (as shown in FIG. 5), and the N pole of the permanent magnet rotor 13 and the N pole of the V-phase electromagnet stator 12 are like poles which repel each other. In the meantime, since the U-phase Hall sensing crystal 111 of the rotor position detector 11 is still in the sensing range of the induced magnet 112 (as shown in FIG. 6C), the S pole of the permanent magnet rotor 13 and the N pole of the U-phase electromagnet stator 12 are unlike poles which attract each other (as shown in FIG. 6C). At this moment, there are still two poles of different phases repelling and attracting each other to drive the pole of the permanent magnet rotor 13 and the pole of the electromagnet stator 12 to produce a relative displacement for the clockwise rotation, so that the permanent magnet rotor 13 continues its rotation. When an end of the induced magnet 112 is beyond the center point of the U-phase Hall sensing crystal 111 (as shown in FIG. 6D), and the S pole of the permanent magnet rotor 13 is displaced to a of mechanical angle 6° before the equilibrium point for attracting the N pole of the U-phase electromagnet stator 12, the U-phase electromagnet stator 12 turns off the magnetic excitation (as shown in FIG. 6D), and only the V-phase electromagnet stator 12 continues the magnetic excitation, and the S pole of the permanent magnet rotor 13 can repel the S pole of the V-phase electromagnet stator 12 to produce a relative displacement to continue the clockwise rotation of the permanent magnet rotor 13.

According to the aforementioned principle of operation, when the front of the induced magnet 112 enters into the W-phase Hall sensing crystal 111 as shown in FIGS. 5, 6E, and 6F, the N pole of the permanent magnet rotor 13 has entered into a mechanical angle of 10° under the pole face of N pole of the W-phase electromagnet stator 12 (as shown in FIGS. 5 and 6E), the front edge of the S pole of the permanent magnet rotor 13 is beyond the mechanical angle of 8° of the pole face of the S pole of the W-phase electromagnet stator 12 (as shown in FIG. 5), and the N pole of the permanent magnet rotor 13 and the N pole of the W-phase electromagnet stator 12 are like poles which repel each other. In the meantime, the V-phase Hall sensing crystal 111 of the rotor position detector 11 is still in the sensing range of the induced magnet 112 (as shown in FIG. 6E), the S pole of the permanent magnet rotor 13 and the N pole of the V-phase electromagnet stator 12 are unlike poles which attract each other (as shown in FIG. 6E). At this moment, there are still two poles of different phases repelling and attracting each other to drive the pole of the permanent magnet rotor 13 and the pole of the electromagnet stator 12 to continue producing a relative displacement for the clockwise rotation and continue the rotation of the permanent magnet rotor 13. When an end of the induced magnet 112 is beyond the center point of the V-phase Hall sensing crystal 111 (as shown in FIG. 6F), and the S pole of the permanent magnet rotor 13 is displaced to a mechanical angle of 6° before the equilibrium point for attracting the N pole of the V-phase electromagnet stator 12, the V-phase electromagnet stator 12 turns off the magnetic excitation (as shown in FIG. 6F), and only the W-phase electromagnet stator 12 continues the magnetic excitation, and the S pole of the permanent magnet rotor 13 continues repelling the S pole of the W-phase electromagnet stator 12 to produce a relative displacement, and thus the permanent magnet rotor 13 continues its clockwise rotation.

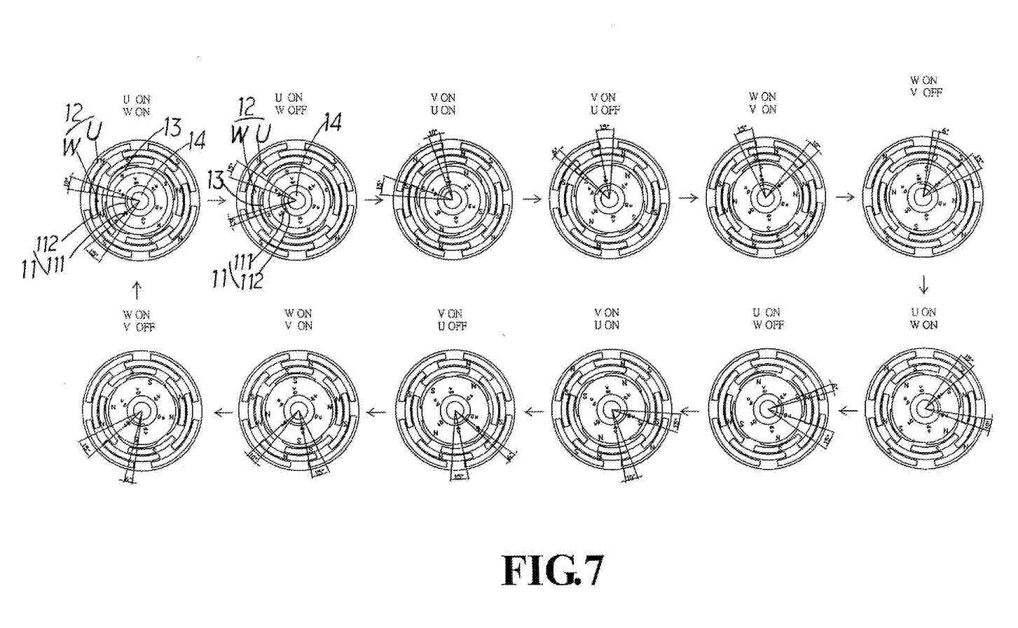

In FIG. 7, the permanent magnet rotor 13 continues its rotation according to the aforementioned principle of operation and the sequence (U→V→W→U→V→W). Since different phases of the electromagnet stator 12 have a difference of the mechanical angle of 60°, therefore when the permanent magnet rotor 13 rotates a round, the electromagnet stator 12 of different phases will be connected and disclosed twice, and such procedure is repeated sequentially, and the Hall effect between the induced magnet 112 coaxially rotated with the motor and the six Hall sensing crystals 111 is provided for detecting a pole position signal of the permanent magnet rotor 13, and the power is amplified by the driver 10 and then supplied to the winding of the motor electromagnet stator 12, so that the pole of the electromagnet stator 12 and the pole of the permanent magnet rotor 13 can repel and then attract each other to produce a relative displacement for the rotation to obtain a multiplied torque. The multiplied torque is used to drive the power generation of the generator, so as to achieve the effects of outputting an electric power by the generator greater than the electric power supplied for the operation of the motor, amplifying the electric power, and saving energy.

In the science of motors, AC motor uses a stator coil to produce a rotating magnetic field by an AC power in order to attract the unlike pole of the rotor and rotate with the rotating magnetic field of the stator, and the DC motor is rotated by a force receiving direction of a current carrying conductor in the magnetic field according to the Fleming's left hand rule. As we all know, regardless of an electromagnet or a permanent magnet, these magnets have the feature of “Like poles repel, and unlike poles attract”. The rotation of the motor may be operated by the principle of “Like poles repel, and unlike poles attract”. According to the Coulomb's law of magnetic flux, the magnitude of the action force between two poles is directly proportional to the product of the magnetic fields of the two poles and inversely proportional to the square of the distance between the two poles. When the value K and the distance between the two poles are constant, an increase or decrease of the magnitude of the magnetic field of any pole will change the torque between the two poles, so that the motor is rotated according to the principle of “Like poles repel, and unlike poles attract”, and the action force applied to each other will produce a relative displacement for the rotation, and the multiplied torque resulted by the interactive action of the two forces is definitely directly proportional to the product of the magnitudes of the magnetic fields of the two poles instead of the torque of a single pole.

In the DC motor with a multiplied torque of this disclosure, the stator is an electromagnet, and the power supply is a DC power supply. The rotor position signal is amplified before it is provided. The rotor is a permanent magnet, and when the position of the rotor pole is changed, the power supply of the stator pole is turned ON or OFF according to the instruction of the rotor position signal, so that the magnetic fields produced between the electromagnet stator and permanent magnet rotor are maintained perpendicular to each other at any moment, and the two magnetic fields are provided for the rotation of the motor due to the relative displaced by the alternate repulsion and attraction between the poles. The position of the rotor pole is changed continuously, and the stator pole and the rotor pole keep producing a relative displacement by the repulsion and then the attraction of the stator pole and the rotor pole, so that the rotor keeps rotating. The larger the load of the rotor, the larger the current of the stator, and the larger the torque of the motor. Since the power of the stator pole is a constant DC, therefore the magnitude of the torque is not related to the rotor angle Θ. If the value of K is a constant, the magnetic field of the rotor (which is a permanent magnet) is a constant, so that the torque T is always directly proportional to the product of the magnetic field of the stator and the magnetic field of the rotor. Therefore, the voltage of the stator can be controlled to control the rotating speed of the motor. Since the power supplied to the electromagnet is a DC power, therefore the rotating speed is not related to the number of poles of the motor. Since the rotor is a permanent magnet that does not require an excitation, the torque of the motor comes from the multiplied torque of the stator and the rotor, therefore the multiplied torque of the mutual action between the two poles is always greater than the torque of a single stator. With a specific power supply, the rotating speed N remains unchanged, and the torque T increases, so that the output power P also increases.

In other words, the DC motor with a multiplied torque of this disclosure adopts a DC power supply and uses a rotor position signal to repel and then attract the stator pole by the rotor pole, so as to produce a relative displacement for the rotation and obtain a multiplied torque. As a result, the multiplied torque is greater than the torque of a single stator, and the multiplied torque is provided for driving the power generation of the generator to achieve the effects of outputting an electric power from the generator greater than the electric power supplied to the motor, amplifying the electric power and saving energy. The technology of this disclosure inevitably creates a page for the development of electric motor and energy source.

In summation, this disclosure has the following advantages:

1. The DC motor of this disclosure has the multiplied torque function, and the rotor adopts a permanent magnet that requires no excitation. The multiplied torque is greater than the torque of a single stator, so that the motor provides a greater output for driving the generator to generate power, and the outputted power is always greater than the electric power supplied for the operation of the motor. The DC motor of this disclosure achieves the effects of amplifying the electric power and saving energy.

2. The DC motor of this disclosure features a simple installation, and a safe and convenient operation, and requires no specific technical skill for the operation.

3. The power generation may be in a small scale. Regardless of home, community, building, or factory, the DC motor may be used independently for the power generation without requiring a large power plant. The DC motor of this disclosure can save a very high cost of the power distribution equipments and maintenance fees.

4. Since no power distribution equipments are required, natural disasters/accidents or damages caused by regional or comprehensive blackouts can be avoided.

5. Since the power generation source is a small power, the quantity of generated power may be expanded unlimitedly without burning fuels or consuming any resources of the earth. There is no danger of lacking electric power sources.

6. Since the power generation requires no fuels, no waste gas will be produced, and no waste product will be produced by the operation, and the environment will not be polluted. The DC motor of this disclosure is an environmentally friendly, clean, and economic power source.

### DESCRIPTION OF NUMERALS

1: DC motor
10: Driver 101: Rotor position signal amplifier detector 102: Power amplifier
11: Rotor position detector 111: Hall sensing crystal 112: Induced magnet
U,V,W: Three phases of electromagnet stator
13: Permanent magnet rotor
14: Motor shaft

What is claimed is:

1. A DC motor with a multiplied torque, comprising a driver, a rotor position detector, an electromagnet stator, and a permanent magnet rotor, characterized in that the driver comprises a rotor position signal amplifier and a power amplifier; the rotor position detector is a rotor position detector with a Hall effect and comprised of six Hall sensing crystals and an induced magnet fixed to a motor shaft, wherein each Hall sensing crystal is separated and configured at a mechanical angle of 60°, and each Hall sensing crystal is installed at a predetermined position on the left side of the center point under a pole face of the N pole of each-phase electromagnet stator pole, and the sequence of the phases is U→V→W→U→V→W; the induced magnet is fixed to the motor shaft by setting the width of the mechanical included angle and rotated synchronously with the motor shaft, and the induced magnet is installed across two Hall sensing crystals, and the front Hall sensing crystal rotated by the induced magnet is sensed to be an ON state, the adjacent rear Hall sensing crystal is delayed and turned OFF, so that the excitations of the two adjacent magnetic fields are overlapped. The electromagnet stator is configured into three windings (U, V, and W phases), and the difference between the mechanical angles of any two windings is 60°, and the windings of three phases of the electromagnet stator are arranged into three layers in the radial direction of the motor, and the windings of different phases are overlapped with each other, and each winding has 4 poles, and each pole has a pole width equal to a mechanical angle of 71°, and the poles are spaced with a mechanical angle of 19°, and the poles of different phase are arranged adjacent to one another in a sequence of N→S→N, and the phase sequence is U→V→W; the wiring of the stator of each phase is connected by Y, wherein the contact point Y and the other U, V, W ends of the contact point Y are input ends of a DC power to form an input of a single-phase DC power;
the permanent magnet rotor is configured into 4 poles arranged into a (N, S, N, S) sequence;
the Hall effect between the induced magnet coaxially rotated with the motor and the 6 Hall sensing crystals is provided for detecting a pole position signal of the permanent magnet rotor, and the electric power is amplified by the power amplifier of the driver and then supplied to the winding of the electromagnet stator of the motor, so that the pole of the electromagnet stator pole is always sequentially turned ON or OFF with the pole of the permanent magnet rotor, and the pole of the permanent magnet rotor and the pole of the electromagnet stator keep repelling and then attracting to produce a relative displacement for the rotation.

2. The DC motor with a multiplied torque according to claim 1, wherein each Hall sensing crystal of the rotor position detector is installed at a position of a mechanical angle of 26° on the left side of the center point under the pole face of the N pole of the electromagnet stator poles of each phase.

3. The DC motor with a multiplied torque according to claim 1, wherein the induced magnet of the rotor position detector is fixed to the motor shaft with a width of a mechanical included angle of 75°.

4. The DC motor with a multiplied torque according to claim 1, wherein when the induced magnet rotated by the front Hall sensing crystal rotor position detector is sensed to be ON, the adjacent rear Hall sensing crystal is delayed by a mechanical angle of 15° and turned OFF, and the excitations of two adjacent magnetic fields of the electromagnet stator is overlapped by a mechanical angle of 15°.

5. The DC motor with a multiplied torque according to claim 1, wherein the front edge of the induced magnet of the rotor position detector, the rear edge of the two N poles of the permanent magnet rotor, and the center point of the motor shaft are configured and extended linearly with respect to one another.

6. The DC motor with a multiplied torque according to claim 1, wherein each of the four poles of the permanent magnet rotor has a width equal to a spacing between a mechanical angle of 69° and a mechanical angle of 21°.

7. The DC motor with a multiplied torque according to claim 1, wherein the electromagnet stator has a magnetic field arranged in a way of having a radial section of the magnetic field winding, a V-phase at the middle of a side of the circumference, and a polar direction of a S pole; the left side is U-phase, and the polar direction is N pole; and the right side is W-phase, and the polar direction is N pole, viewing from the axial direction of the motor.

8. The DC motor with a multiplied torque according to claim 1, wherein the six Hall sensing crystals of the rotor position detector are sequentially numbered by U equal to 1, 4, V equal to 2, 5, and W equal to 3, 6, and when the six Hall sensing crystals are arranged sequentially clockwise, the power of the rotor position signal detected by the first and fourth Hall sensing crystals is amplified by the power amplifier of the driver and supplied to an U-phase stator power supply of the motor; the power of rotor position signal detected by the second and fifth Hall sensing crystals is amplified by the power amplifier of the driver and supplied to a V-phase stator power supply of the power amplifier; the power of the rotor position signal detected by the third and sixth Hall sensing crystals is amplified by the power amplifier of the driver and supplied to a W-phase stator power supply of the motor.

9. The DC motor with a multiplied torque according to claim 1, wherein when the front Hall sensing crystal of the rotor position detector is induced and conducted by the induced magnet, the adjacent rear Hall sensing crystal is delayed by a mechanical angle of 15° and turned off, so that the rear end of the N pole of the permanent magnet rotor enters into a mechanical angle of 10° under the pole face of the N pole of the electromagnet stator to drive the N pole of the electromagnet stator of the phase and the N pole of the permanent magnet rotor to be like poles that repel each other, and the N pole of the electromagnet stator of the rear phase and the S pole of the permanent magnet rotor to be unlike poles that attract each other, so that the electromagnet at this moment has 2-phase poles repelling and then attracting the pole of the permanent magnet rotor to drive the pole of the permanent magnet rotor and the pole of the electromagnet stator to produce a relative displacement for the operation, and when the rear end of the induced magnet enters into the center point of the rear Hall sensing crystal, and displaces the S pole of the permanent magnet rotor to a position before a mechanical angle of 6° of an equilibrium point to attract the N pole of the rear-phase electromagnet stator, the excitation of the rear-phase electromagnet stator is turned off, and only the front-phase electromagnet stator continues the magnetic excitation, so that the S pole of the permanent magnet rotor keeps repelling the S pole of the front-phase electromagnet stator to produce the relative displacement for the operation.

10. The DC motor with a multiplied torque according to claim 1, wherein the permanent magnet of the permanent magnet rotor has an external periphery in an arc shape with a thicker center point and two thinner ends.
